(19) United States
(12) Patent Application Publication
(10) Pub. No.: US 2025/0315749 A1
(43) Pub. Date: Oct. 9, 2025

(54) MULTI-AGENT MODELING FOR ENERGY

(71) Applicant: Enverus, Inc., Austin, TX (US)

(72) Inventors: Sean O'Loughlin, Landenberg, PA (US); Cesar Garza, Mission, TX (US); Yue Qiu, Chadds Ford, PA (US); Jiarao Huang, Calgary (CA); Livan Alonso, Bryn Mawr, PA (US); Gabrielle Sunderland, Bellingham, WA (US)

(73) Assignee: Enverus, Inc., Austin, TX (US)

(21) Appl. No.: 19/169,224

(22) Filed: Apr. 3, 2025

Related U.S. Application Data
(60) Provisional application No. 63/573,514, filed on Apr. 3, 2024.

(51) Int. Cl. G06Q 10/0631

(52) U.S. Cl. CPC G06Q 10/06311; G06Q 10/06316

(57) ABSTRACT

A coordination agent of a multi-agent artificial intelligent system receives a user prompt related to an energy industry operation via a prompt interface. The coordination agent analyzes the user prompt to interpret content, intent, and relevant context associated with the energy industry operation. The coordination agent generates a workflow based on an analysis of the user prompt. The coordination agent communicates the workflow to the plurality of professional agents via a shared message pool. The coordination agent receives, from the plurality of professional agents, responses to the workflow. The coordination agent compiles a response to the user prompt based on the received responses from the plurality of professional agents.

### FIELD OF DISCLOSURE

The present disclosure generally relates to a multi-agent artificial intelligent system, and more specifically, to systems, methods, and devices that utilize large language models for coordinating and executing tasks within the energy industry.

### BACKGROUND

The energy industry is a complex and dynamic field that requires the integration of various specialized tasks and processes. These tasks often involve intricate analyses, such as geological evaluations, production optimization, and financial assessments. Traditionally, these tasks have been performed by separate teams or individuals, each with their own specialized knowledge and expertise. However, the increasing complexity and interdependence of these tasks have highlighted the potential benefits of a more integrated and coordinated approach.

### SUMMARY

In some embodiments, a method for coordinating tasks within an energy industry using a multi-agent artificial intelligence system is disclosed herein. A coordination agent of a multi-agent artificial intelligent system receives a user prompt related to an energy industry operation via a prompt interface. The coordination agent analyzes the user prompt to interpret content, intent, and relevant context associated with the energy industry operation. The coordination agent generates a workflow based on an analysis of the user prompt. The workflow defines a sequence of tasks to be executed by a plurality of professional agents. Each task corresponds to a specialized function within the energy industry. The coordination agent communicates the workflow to the plurality of professional agents via a shared message pool. Each professional agent is configured to perform a specific role related to the user prompt. The coordination agent receives, from the plurality of professional agents, responses to the workflow. Each response includes outputs from tasks executed by the plurality of professional agents. The coordination agent compiles a response to the user prompt based on the received responses from the plurality of professional agents. The response is tailored to address the user prompt within a context of the energy industry operation.

In some embodiments, a non-transitory computer readable medium is disclosed herein. The non-transitory computer readable medium includes one or more sequences of instructions, which, when executed by a processor, causes a computing system to perform operations. The operations include receiving, by a coordination agent of a multi-agent artificial intelligent system, a user prompt related to an energy industry operation via a prompt interface. The operations further include analyzing, by the coordination agent, the user prompt to interpret content, intent, and relevant context associated with the energy industry operation. The operations further include generating, by the coordination agent, a workflow based on an analysis of the user prompt. The workflow defines a sequence of tasks to be executed by a plurality of professional agents. Each task corresponds to a specialized function within the energy industry. The operations further include communicating, by the coordination agent, the workflow to the plurality of professional agents via a shared message pool. Each professional agent is configured to perform a specific role related to the user prompt. The operations further include receiving, by the coordination agent from the plurality of professional agents, responses to the workflow. Each response includes outputs from tasks executed by the plurality of professional agents. The operations further include compiling, by the coordination agent, a response to the user prompt based on the received responses from the plurality of professional agents. The response is tailored to address the user prompt within a context of the energy industry operation.

In some embodiments, a system is disclosed herein. The system includes a coordination agent and a plurality of professional agents. The plurality of professional agents communicates with the coordination agent via a shared message pool. The coordination agent and the plurality of professional agents configured to perform operations. The operations include receiving, by the coordination agent of a multi-agent artificial intelligent system, a user prompt related to an energy industry operation via a prompt interface. The operations further include analyzing, by the coordination agent, the user prompt to interpret content, intent, and relevant context associated with the energy industry operation. The operations further include generating, by the coordination agent, a workflow based on an analysis of the user prompt. The workflow defines a sequence of tasks to be executed by the plurality of professional agents. Each task corresponds to a specialized function within the energy industry. The operations further include communicating, by the coordination agent, the workflow to the plurality of professional agents via the shared message pool. Each professional agent is configured to perform a specific role related to the user prompt. The operations further include receiving, by the coordination agent from the plurality of professional agents, responses to the workflow. Each response includes outputs from tasks executed by the plurality of professional agents. The operations further include compiling, by the coordination agent, a response to the user prompt based on the received responses from the plurality of professional agents. The response is tailored to address the user prompt within a context of the energy industry operation.

### BRIEF DESCRIPTION OF FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments.

FIG. 2 is a block diagram illustrating a multi-agent framework system, according to example embodiments.

FIG. 3 is a block diagram illustrating communication between professional agents and analytical models, according to example embodiments.

FIG. 4 is a block diagram illustrating a computing system, according to example embodiments.

FIG. 5 is a block diagram illustrating a computing system, according to example embodiments.

FIG. 6 is a schematic diagram illustrating a workflow of a multi-agent framework system, according to example embodiments.

FIG. 7 is a schematic diagram illustrating a workflow of a multi-agent framework system, according to example embodiments.

FIG. 8 is a flow diagram illustrating a method of generating a response to a user prompt utilizing a multi-agent framework system, according to example embodiments.

FIG. 9A is a block diagram illustrating a computing device, according to example embodiments of the present disclosure.

FIG. 9B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The following description sets forth exemplary embodiments of the present disclosure. It should be recognized, however, that such description is not intended as a limitation on the scope of the present disclosure. Rather, the description also encompasses combinations and modifications to those exemplary embodiments described herein.

In recent years, the field of artificial intelligence (AI) has seen remarkable advancements, particularly in the area of large language models (LLMs). These models, such as GPT-3.5 and GPT-4, have demonstrated a broad understanding of language and adaptability to various contexts. They have been used in a wide range of applications, from natural language processing to data analysis, and have shown great promise in interpreting complex tasks and coordinating responses.

In the context of the energy industry (e.g., oil, gas, wind farm, solar farm, etc.), there is a growing interest in leveraging the capabilities of these AI models to streamline and optimize various tasks. For instance, the use of AI can potentially enhance the efficiency and accuracy of tasks such as land purchasing, well cost estimation, and production optimization. Moreover, AI models can facilitate communication and coordination among different teams or individuals, thereby promoting a more integrated and holistic approach to problem-solving.

One emerging trend in AI is the use of multi-agent systems, where multiple AI agents work together to achieve a common goal. These systems can be designed to include a coordination agent and several professional agents, each with their own specialized roles and capabilities. The coordination agent can interpret user requests and determine which professional agents are suitable to respond, while the professional agents can execute specific tasks based on their specialized knowledge and the instructions received.

The use of multi-agent systems in the energy industry can potentially offer several benefits. For instance, it can facilitate the integration of various tasks and processes, thereby promoting efficiency and coherence. Moreover, it can enhance the adaptability and flexibility of the system, as different agents can be tailored to their specific roles and can communicate with each other to coordinate their responses. However, the design and implementation of such multi-agent systems can be challenging, given the complexity and diversity of tasks in the energy industry.

One or more techniques disclosed herein leverage artificial intelligence, specifically large language models, to coordinate and execute tasks within the energy industry. In some embodiments, the disclosure may provide a multi-agent framework that allows users to submit requests in a natural language format via a prompt interface. These requests may then be processed by a multi-agent system, which may include a coordination agent and several professional agents.

The multi-agent framework may offer several benefits. For instance, it may facilitate the integration of various tasks and processes, thereby promoting efficiency and coherence. Moreover, it may enhance the adaptability and flexibility of the system, as different agents can be tailored to their specific roles and can communicate with each other to coordinate their responses. This multi-agent framework may be particularly beneficial in the energy industry, where tasks are complex and diverse, and require a deep understanding of both the technical aspects of AI and the specific requirements and constraints of the industry.

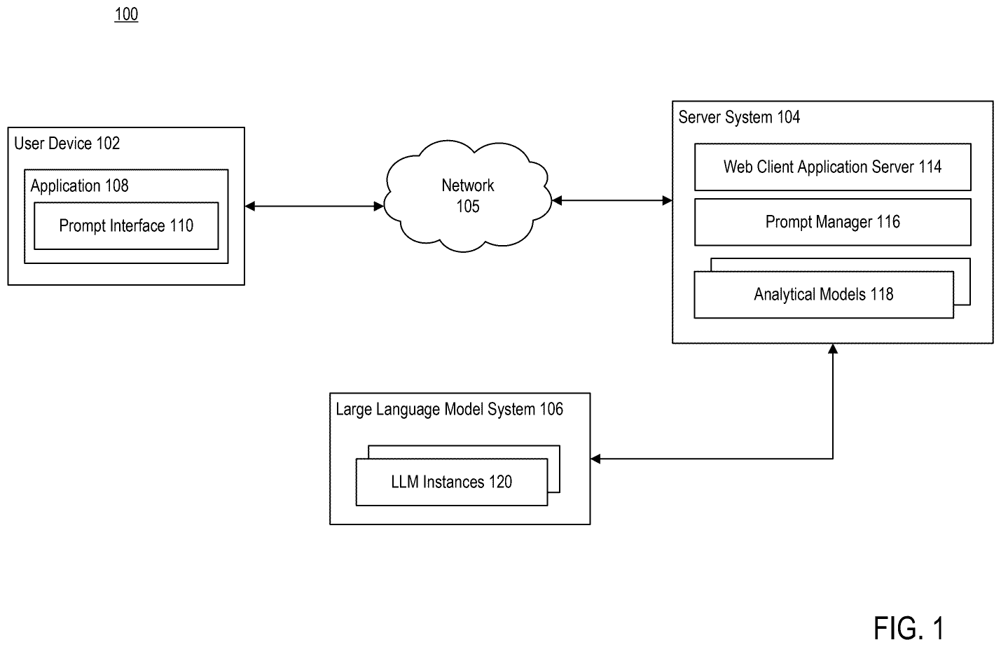

FIG. 1 is a block diagram illustrating a computing environment 100, according to example embodiments. As shown, computing environment 100 may include a user device 102 and a server system 104 communicating via a network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user. For example, user device 102 may be associated with a user or subscriber associated with server system 104. In some embodiments, user device 102 may be representative of a mobile device, a tablet, a desktop computer, or any computing system having capabilities described herein. User device 102 may include an application 108 executing thereon. Application 108 may be representative of an application associated with server system 104. In some embodiments, application 108 may be a standalone application associated with server system 104, such as a mobile application, tablet application, or, more generally, a software application affiliated with an entity associated with server system 104. In some embodiments, application 108 may be representative of a web browser configured to communicate with server system 104.

Application 108 may include a prompt interface 110. Prompt interface 110 may be representative of an input field configured to receive requests from users of user device 102. For example, via prompt interface 110, a user can submit a prompt or request, in natural language format, to server system 104. In some embodiments, the prompt may be associated with a request in the energy space, such as the fields of oil and gas, and more broadly, energy. An exemplary prompt may be: “I'm looking to buy some land in the Delaware basin. Could you please provide the top 10 options based on full cycle break event cost?” Once the user submits the prompt via prompt interface 110, application 108 may forward the prompt to server system 104 for analysis.

Server system 104 may include web client application server 114, prompt manager 116, and analytical models or tools 118. Prompt manager 116 may be comprised of one or more software modules. The one or more software modules are collections of code or instructions stored on a media (e.g., memory of server system 104) that represent a series of machine instructions (e.g., program code) that implements one or more algorithmic steps. Such machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Prompt manager 116 may be configured to receive prompts from application 108 and relay the prompt to large language model system 106 via one or more application programming interfaces (APIs). Large language model system 106 may be representative of one or more large language models, such as, but not limited to ChatGPT (e.g., ChatGPT 4.0, ChatGPT 3.5, or any future iteration of ChatGPT) commercially available from OpenAI, Bard commercially available from Google, LLAMA commercially available from Meta, and the like.

As shown, large language model system 106 may include one or more large language model (LLM) instances 120. LLM instances 120 may be representative of large language models hosted by large language model system 106 that were trained or fine-tuned by an operator or entity associated with server system 104. In some embodiments, LLM instances 120 may not be publicly accessible. Instead, in order to access LLM instances 120, application 108 may first communicate with server system 104, which then may, in turn, communicate or relay the prompt to LLM instances 120 via one or more APIs. In some embodiments, rather than rely on prompt manager 116 as an intermediary between application 108 and LLM instances 120, application 108 may forward the prompt directly to LLM instances 120 via the one or more APIs.

Each LLM instance 120 may be representative of a fine-tuned large language model trained to perform a specific role in the process. In some embodiments, each LLM instance 120 may be configured to communicate with one or more analytical models or tools 118 associated with server system 104. Analytical models or tools 118 may be representative of pre-trained models or tools configured to provide end users with various metrics related to the energy industry or, more specifically, the oil and gas industry. Exemplary analytical models or tools 118 may include, but are not limited to: well cost, economics, spacing, placed well optimization, type curves, completion optimization, production forecasting, undeveloped land, operator tagging, well landing zone, well interference, refract detection.

In some embodiments, one or more analytic models or tools 118 may include a placed well tool. Placed well tool may be utilized to answer questions related to a well placement scenario. In some embodiments, placed well tool may be configured to receive one or more parameters, which may include, but are not limited to well spacing, well minimum lateral length, well maximum lateral length, existing well locations, and extent geometry file. In operation, for example, placed well tool may notify prompt manager 116 that input parameters, such as, but not limited to one or more of well spacing, well minimum lateral length, well maximum lateral length, existing well locations, and extent geometry file, may be provided by the user for LLM instances 120 to extract from an input or prompt fields. In some embodiments, placed well tool may instruct or notify prompt manager 116 that a data access tool should be used to query a well data set (e.g., Prism well data set) to calculate the average spacing or lateral length requirement.

In some embodiments, LLM instances 120 may extract the ExistingWellLocations and ExtentGeometry parameters using either a user service tool or a GeoData Tool. For example, placed well tool may instruct LLM instances 120 to prompt the user for to provide the name of their area of interest or the name of the county they want to run their placed wells scenario in. Both the user service tool and the GeoData tool can calculate the Existing WellLocations and ExtentGeometry file.

In some embodiments, the user service tool, may be an endpoint to which the user provides the name of their area of interest. In response, user service tool may return all the areas of interest that are available and if there's a match to that AOI we calculate the existing wells based on a SQL query built on the wells table derived by the Placed Well Studio Product workflow, and the ExtentGeometry file is provided as an output to the User Service Tool and we have to base64 encode it.

In some embodiments, the GeoData Tool may be an endpoint from the GeoData service. The GeoData tool may be configured to return geolocation data that one or more analytical models or tools 118 may then transform into the base64 encoded geojson data. One or more analytical models or tools 118 may then follow a SQL query built on the wells table using the geojson data to calculate the ExistingWellLocations.

In some embodiments, one or more analytical models or tools 118 may include a well cost tool. In some embodiments, the well cost tool may be configured to calculate various costs relating to a well. Exemplary costs may include, but are not limited to, drilling cost, completion cost, and tie-in-facilities cost. In some embodiments, the well cost tool may be called using a model serving endpoint based on the existing well cost model. The input parameters to the well cost tool may include, but are not limited to: RSRegion, RSBasin, RSPlay, RSInterval, wellIdentifier, LateralLengthFt, MMCoef, NumberOfStages, Operator, TotalFluidBBL, TotalProppantMassLbs, True VerticalDepth, and MultipleFlag. The MultipleFlag input may be used to differentiate between call the well cost tool to iterate over a single well or multiple wells at once.

In some embodiments, prompt manager 116 may be instructed regarding the different workflows available that use the well cost tool. This includes differentiating what input parameters well cost tool receives as input compared to what can be imputed using a data access tool that creates SQL queries to estimate input parameters based on user filters. For example, a user may not need to provide LateralLengthFt, if the user asks prompt manager 116 to estimate a well cost based on an average well in the Delaware play because prompt manager 116 may interface with the data access tool to filter to wells in the Delaware and calculate the average LateralLengthFt.

Additionally, some parameter values, like for MMCoef, if not provided by the user, can be calculated with a curated SQL query to directly call the data access tool based on how the well cost model workflow calculates this parameter, which is the discount factor based on the average number of wells an operator has in a given play within a specific time period.

In some embodiments, other parameters like TotalProppantMassLbs, TotalFluidBBL, NumberOfStages, TrueVerticalDepth have a curated SQQL query to mimic how placed well economics calculates these parameters based on a specific placed well output scenario. These parameters calculate the average value normalized based on lateral length, then the system multiples by the input lateral length.

In some embodiments, the well cost tool uses a MultipleFlag parameter to differentiate if the user prompts prompt manager 116 to calculate well costs over multiple wells. For example, prompt manager 116 may be configured to handle the case where a user prompts the system to calculate the total well cost over placed well scenarios. In this case, the MultipleFlag parameter may be used to adjust the input parameters to lists as needed, as the other parameters are normalized based on Lateral Length.

In some embodiments, one or more analytical models or tools 118 may include an autocurve tool. Auto-curve tool may be configured to generate a production curve based on user inputs. Exemplary user inputs may include, for example, RSRegion, RSBasin, RSPlay, RSInterval, MonthsOfProd, LateralLengthFt, and Spacing. These user inputs may be selected based on the placed well economics workflow to estimate the forecasted oil and gas production, contingent on it being used in a well placement scenario.

In some embodiments, one or more analytical models or tools 118 may include a well level economics tool. Well level economics tool may be configured to calculate the economics associated with a given well based on certain input criteria, thus allowing analysis over hypothetical wells. Various economic values may be returned, as output, associated with the well economics model that is accessed through a model serving endpoint. Exemplary outputs may include net present value of a given well given its production across a predefined period of time.

In some embodiments, prompt manager 116 may be configured to instruct each agent how to extract all the inputs required to call the well economics model. Exemplary workflows may include:

The user can use the well cost tool to calculate the various associated well costs with the same input requirements previously discussed.

The user can use the autocurve tool to calculate the Calendar Year Day Oil and Gas input parameters with the same input requirements previous discussed.

The user can ask to estimate the remaining input parameters based on a given filter. This means the user can provide at least one filter along the lines of “based on wells in the {play name} Play” so that the agent can calculate average values based on the Data Access Tool.

In some embodiments, the one or more analytical models or tools 118 may include field development tool. The field development tool may be configured to calculate a production forecast for a user-created inventory of wells, rig data, and existing production dataset and plots the resultant production time series visualization. Field development tool may receive, as input, the name of the user created inventory, rig, and PDP (existing production) datasets made in the field development studio product, and the name of the production forecast dataset they will create through the tool. In some embodiments, field development tool may use a data source tool to retrieve the data source id of the user-defined inventory, rig, and PDP datasets. In some embodiments, field development tool may use an mi6 endpoint to call the fdp scheduler that receives, as input, the name of the user created inventory, rig, and PDP. Field development tool may be configured to create an output data source containing the production forecast per rig. There is a separate interface to call this backend agent endpoint.

In some embodiments, the one or more analytical models or tools 118 may include helper tools. Helper tools may include a data access tool, a user service tool, a geo data tool, a data source tool, and a calculator tool.

In some embodiments, data access tool may be configured to execute queries from internal data sources using the data access service endpoint that receives, as input, a query and returns the corresponding data of that query. Data access tool may be used for input parameter imputation, to provide a space to estimate the required parameters for certain workflows above instead of having the user provide every model input requirement if they want to estimate instead.

In some embodiments, user service tool may be configured to extract the parameters used by the placed well tool, such as Existing WellLocations and GeometryExtent file, based on the area of interest name. User service tool may be configured to make a request to the user service endpoint based on the area of interest name and returns the data.

In some embodiments, geo data tool may be used to extract input parameter information for the placed well tool, such as ExistingWellLocations and GeometryExtent file, based on the county name.

In some embodiments, data source tool may be configured to generate the data source identifier based on the data source name using the data source service.

In some embodiments, calculator tool may be configured to receive, as input, a mathematical expression and evaluates it using LLMMathChain. This is used for help with unit conversions.

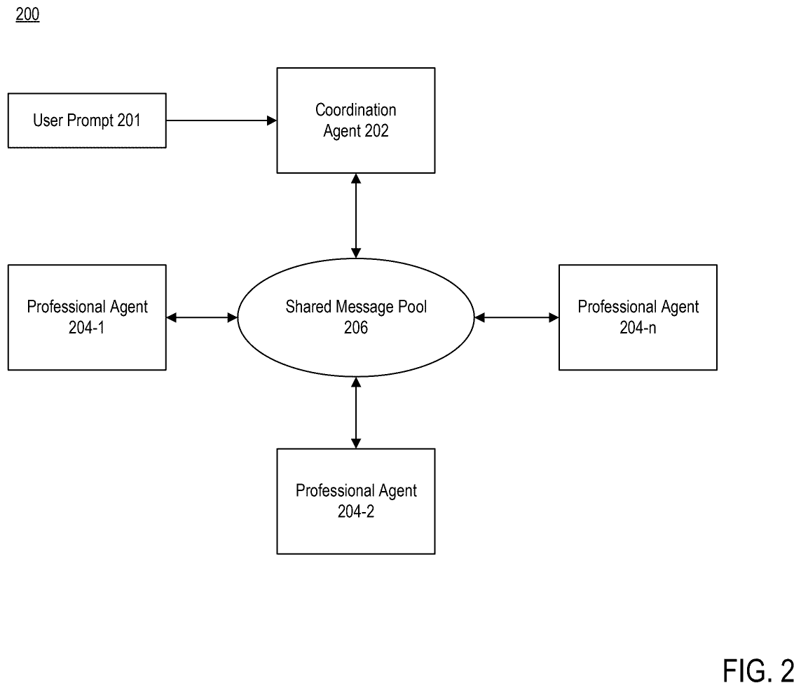

FIG. 2 is block diagram illustrating a multi-agent framework system 200, according to example embodiments. Multi-agent framework system 200 may be representative of a framework that includes a plurality of LLM instances (e.g., LLM instances 120) communicating via a shared message pool 206. For example, as shown, multi-agent framework system 200 may include a coordination agent 202 and a plurality of professional agents 204-1, 204-2, and 204-n (generically “professional agent 204”) communicating via shared message pool 206.

Coordination agent 202 may be representative of an LLM instance trained or fine-tuned to receive user input in the form of a user prompt 201, interpret the prompt, and generate a workflow or plan for responding to user prompt 201. For example, coordination agent 202 may analyze the content, intent, and relevant context of user prompt 201 to determine which professional agents 204 are needed to generate a response.

Coordination agent 202 may generate a series of messages or tasks that may be posted to shared message pool 206 based on its understanding of the content, intent, and relevant context of user prompt 201. Shared message pool 206 may be representative of a communication medium through which coordination agent 202 and professional agents 204 communicate. For example, coordination agent 202 may send instructions to professional agents 204 via shared message pool 206. In some embodiments, these instructions may be structured messages containing specific requirements and deliverables related to the user's request.

Professional agents 204 may be representative of LLM instances trained or fine-tuned to play a specific role in the workflow. For example, each professional agent 204 may be individually trained or fine-tuned to solve specific tasks related to user prompt 201. In some embodiments, each professional agent 204 may be fine-tuned or trained to identify instructions assigned to it shared message pool 206 and understand the specific requirements and deliverables in the instructions. Each professional agent 204 agent may have access to one or more analytical models or tools 118 based on their role.

Using a specific example, one professional agent 204 may be a finance agent. The finance agent may be trained or fine-tuned to call a well cost analytical model and economics analytical model based on the inputs and parameters in the instructions assigned to it in shared message pool 206. The finance professional agent may be fine-tuned or trained to call those models as needed, use those models as “domain expertise”, feed appropriate inputs and parameters to those models, and validate the model outputs. If the outputs are valid, the finance professional agent may proceed to share the outputs through shared message pool 206. If the outputs are not valid, the finance professional agent may adjust the inputs and parameters until it yields reasonable model outputs.

In some embodiments, professional agents 204 may also communicate with each other using a standardized protocol or language designed for inter-agent communication. In some embodiments, this communication may occur via shared message pool 206. In some embodiments, this communication may occur via direct communication between two or more professional agents 204.

In some embodiments, the overall layout of multi-agent framework system 200 may demonstrate a centralized system where the coordination agent 202 acts as an intermediary between the user's input and the professional agents 204, with the shared message pool 206 facilitating the communication within multi-agent framework system 200. In some embodiments, multi-agent framework system 200 may be more specialized and structured, with a clear division of roles and a centralized coordination mechanism.

In some embodiments, human judgment can guide and correct the results of professional agents 204. For example, an end user may adjust outputs generated by professional agents 204 resulting in more accurate and reliable results. Such end user interaction may be invaluable, for example, in situations where automated processes may trouble. In some embodiments, such process may take the form of an end user specifying requirements or criteria before or after receiving a workflow or plan generated by coordination agent 202 in response to a user's prompt. In some embodiments, an end user may ask for a specific output validation. For example, an end user may ask for output validation for specific steps through the prompt sent to coordination agent 202. Using a specific example, a user may specify: “I would like to verify the optimized completion parameters from the production agent.” Such request may act like a breakpoint to the workflow. For example, the workflow set out by coordination agent 202 may not proceed without confirming a green light from a user.

In some embodiments, coordination agent 202 and professional agents 204 may be fine-tuned, allowing them to learn from real-world input and interactions.

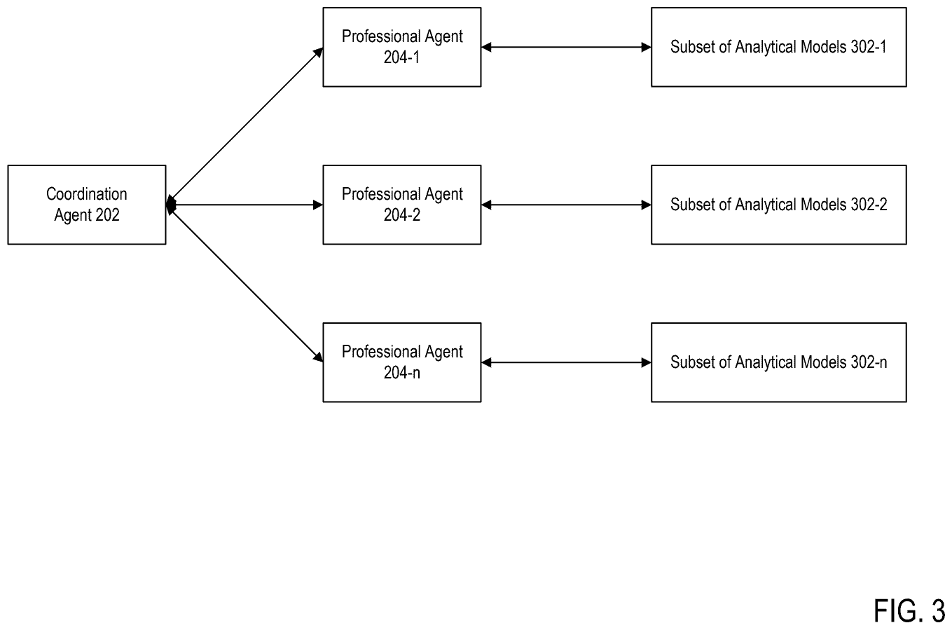

FIG. 3 is a block diagram illustrating communication between professional agents and analytical models, according to example embodiments.

As shown, coordination agent 202 may instruct each professional agent 204-1, 204-2, and 204-n. Each professional agent 204 may be provided with access to a subset of analytical models or tools 118. For example, as shown, professional agent 204-1 may be provided with access to subset of analytical models 302-1; professional agent 204-2 may be provided with access to subset of analytical models 302-2; and professional agent 204-n may be provided with access to subset of analytical models 302-n. Although analytical models 302-1, 302-2, and 302-n are shown as separate and distinct analytical models, those skilled in the art understand that there may be overlap between the models in each subset. In other words, a given analytical model may be a member of two or more subsets of analytical models.

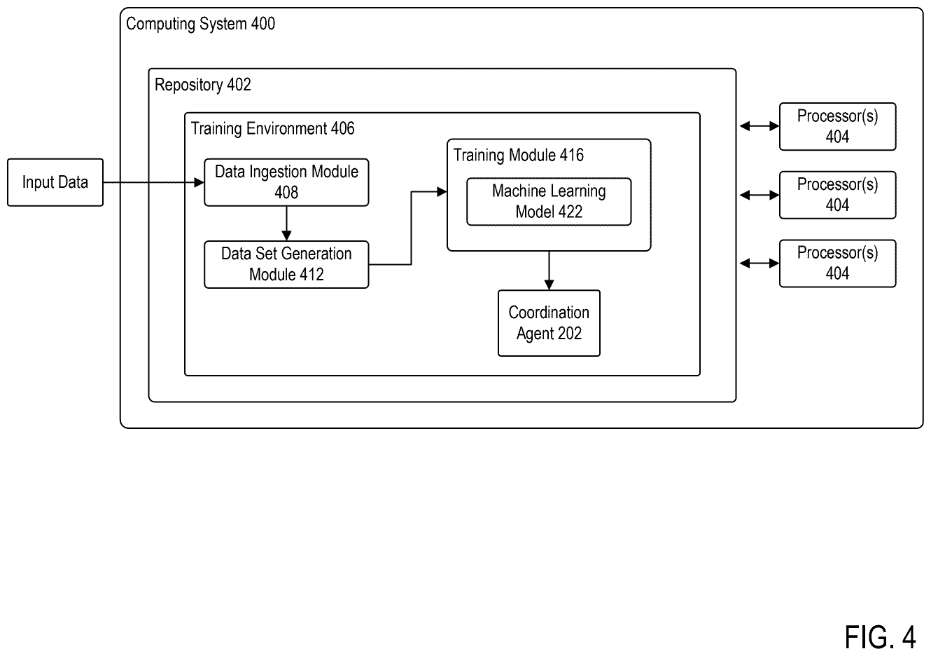

FIG. 4 is a block diagram illustrating a computing system 400, according to example embodiments. As shown, FIG. 4 may represent a training environment in which a large language model may be trained to function as a coordination agent. Computing system 400 may include a repository 402 and one or more computer processors 404.

Repository 402 may be representative of any type of storage unit and/or device (e.g., a file system, database, collection of tables, or any other storage mechanism) for storing data. Further, repository 402 may include multiple different storage units and/or devices. The multiple different storage units and/or devices may or may not be of the same type or located at the same physical site. As shown, repository 402 includes at least training environment 406.

Training environment 406 may include data ingestion module 408, data set generation module 412, and training module 416. Each of data ingestion module 408, data set generation module 412, and training module 416 may include one or more software modules. The one or more software modules can be collections of code or instructions stored on a media (e.g., memory of computing system 400) that represent a series of machine instructions (e.g., program code) that implements one or more algorithmic steps. Such machine instructions may be the actual computer code the processor of computing system 400 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Data ingestion module 408 may be configured to receive input data for training a machine learning model. In some embodiments, input data may be representative of a large data set that includes diverse user inputs and scenarios. In some embodiments, the input data may include domain-specific data, such as data from real estate databases or geographical information systems in order to understand and process specialized queries in the energy domain or, more specifically, the oil and gas domain.

Data set generation module 412 may receive the input data from data ingestion module 408. In some embodiments, data set generation module 412 may pre-process or format the input data in a manner fit for training machine learning model 422. For example, as those skilled in the art understand, because machine learning model 422 is representative of a large language model, training or fine tuning the large language model may require the training data to be of a particular data format. Data set generation module 412 may be configured to transform or translate the input data into the format required for training.

Training module 416 may be configured to train machine learning model 422 to understand of the content, intent, and relevant context of a given user prompt. For example, training module 416 may employ a supervised training technique to train machine learning model 422 to understand the content, intent, and relevant context of a user prompt based on the training data set generated by data set generation module 412. In some embodiments, training module 416 may further train machine learning model 422 to understand which professional agents may be needed for a given user prompt or workflow. Once machine learning model 422 achieves a threshold level of accuracy, training module 416 may output a trained coordination agent 202 for deployment.

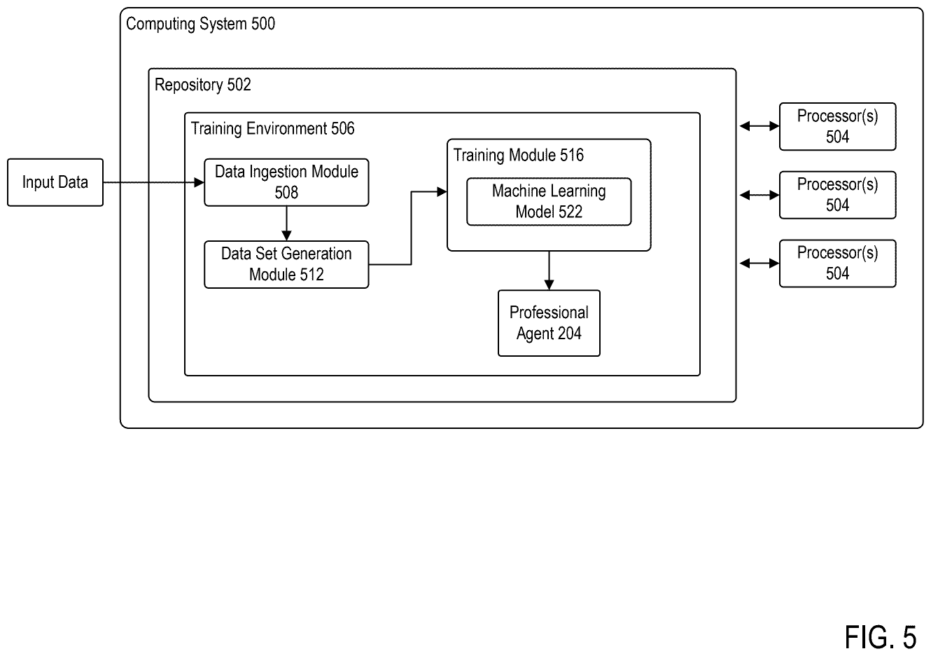

FIG. 5 is a block diagram illustrating a computing system 500, according to example embodiments. As shown, FIG. 5 may represent a training environment in which a large language model may be trained to function as a professional agent. As those skilled in the art understand, because each professional agent is tasked with a specific role in the process, each professional agent needs to be fine-tuned or trained independently with its own relevant data set. FIG. 5 illustrates a training of a generic professional agent with examples related to specific professional agents. Computing system 500 may include a repository 502 and one or more computer processors 504.

Repository 502 may be representative of any type of storage unit and/or device (e.g., a file system, database, collection of tables, or any other storage mechanism) for storing data. Further, repository 502 may include multiple different storage units and/or devices. The multiple different storage units and/or devices may or may not be of the same type or located at the same physical site. As shown, repository 502 includes at least training environment 506.

Training environment 506 may include data ingestion module 508, data set generation module 512, and training module 516. Each of data ingestion module 508, data set generation module 512, and training module 516 may include one or more software modules. The one or more software modules can be collections of code or instructions stored on a media (e.g., memory of computing system 500) that represent a series of machine instructions (e.g., program code) that implements one or more algorithmic steps. Such machine instructions may be the actual computer code the processor of computing system 500 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Data ingestion module 508 may be configured to receive input data for training a machine learning model. In some embodiments, input data may be representative of a large data set that includes diverse user inputs and scenarios. In some embodiments, the input data may include domain-specific data, such as data from real estate databases or geographical information systems in order to understand and process specialized queries in the energy domain or, more specifically, the oil and gas domain.

Data set generation module 512 may receive the input data from data ingestion module 508. In some embodiments, data set generation module 512 may pre-process or format the input data in a manner fit for training machine learning model 522. For example, as those skilled in the art understand, because machine learning model 522 is representative of a large language model, training or fine tuning the large language model may require the training data to be of a particular data format. Data set generation module 512 may be configured to transform or translate the input data into the format required for training.

Training module 516 may be configured to train machine learning model 522 to identify instructions assigned to it by coordination agent 202 and understand the specific requirements and deliverables in the instructions. In some embodiments, machine learning model 522 may be further trained to learn which analytical models or tools 118 to communicate with based on the specific requirements and deliverables in the instructions. Once machine learning model 522 achieves a threshold level of accuracy, training module 516 may output a trained professional agent 204 for deployment.

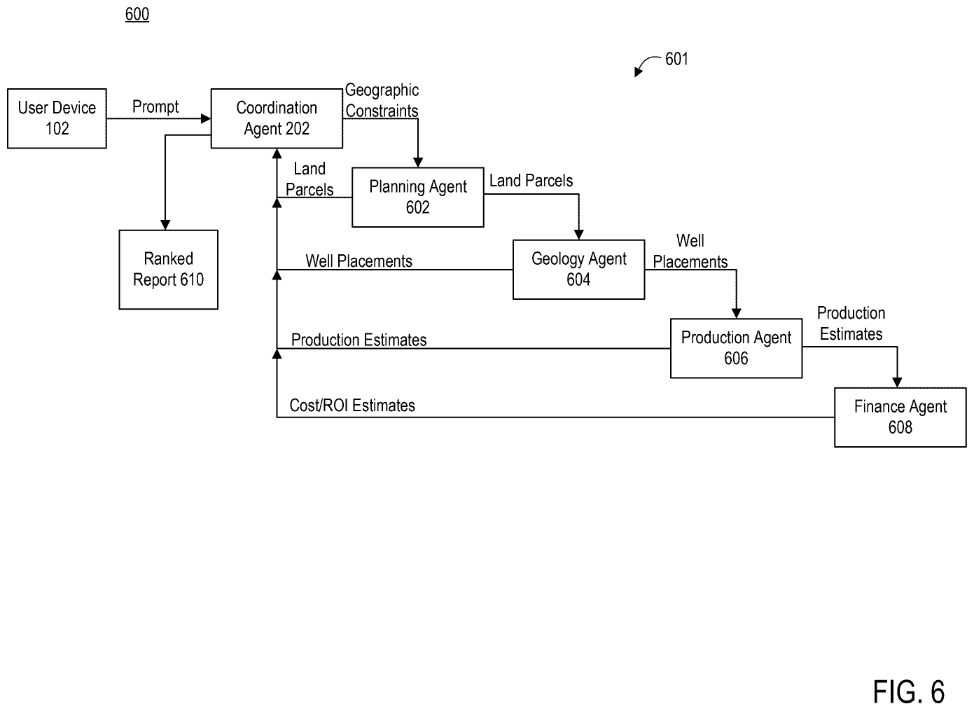

FIG. 6 is a schematic diagram illustrating a workflow 600 of a multi-agent framework system 601, according to example embodiments.

As shown, workflow 600 may being with user device 102 submitting a prompt. In some embodiments, user device 102 may submit a prompt via prompt interface 110 of application 108. In some embodiments, the user's prompt may be sent to server system 104. In such embodiments, server system 104 may send the prompt to LLM instances 120 via one or more APIs. In some embodiments, rather than send the user's prompt to server system 104, application 108 may route the user's prompt directly to LLM instances 120 via the one or more APIs, bypassing server system 104. In this particular example, the user's prompt may be: “I′m looking to buy some land in the Delaware basin. Could you please provide the top 10 options based on fully cycle break even cost.”

As shown, workflow 600 may utilize a plurality of professional agents. For example, as shown, workflow 600 may utilize planning agent 602, geology agent 604, production agent 606, and finance agent 608. geology agent 604 and production agent 606. Each of planning agent 602, geology agent 604, production agent 606, and finance agent 608. Geology agent 604 and production agent 606 may oversee a particular step in providing an answer to the user's prompt.

Planning agent 602 may be instructed to gather land for sale information in the Delaware Basin. Geology agent 604 may be instructed to perform a geological analysis of the land, including formation and geographic characteristics. Production agent 606 may be instructed to generating the engineering design to optimize the well production per lateral foot and may use the optimized completion and spacing parameters to predict the oil/gas production for 30 years. Finance agent 608 may be instructed to perform a financial analysis to calculate the full life-cycle breakeven, including the land, well cost, and discounted cash flow from oil/gas production for the well's life. Each of planning agent 602, geology agent 604, production agent 606, and finance agent 608 may provide their answers to the shared message pool, such that coordination agent may generate a ranked report 610 that includes an answer to the user's prompt. Coordination agent 202 may deliver ranked report 610 to user device 102 via application 108.

To elaborate on workflow 600 further, consider the instructions generated by coordination agent 202 for planning agent 602. Coordination agent 202 may determine that the first step in workflow 600 is to fetch land data for sale in Delaware Basin, including coordinates, owner, and price. Coordination agent 202 may generate the following message intended for planning agent 602:
Message:
Date: 2024 Jan. 25
Sent_by: Coordination agent
Sent_to: Planning agent
Requirement: Gather data of land for sale in Delaware in the past 12 months.
Comments: Exclude the M&A opportunity. Limit the results to the most recent 100 records.
Preferred data source: Enverus Business Development
Next_agent: Geology agent

Once planning agent 602 receives the message from the shared message pool, planning agent 602 may initiate the analysis of the message and generate an answer for coordination agent 202. In some embodiments, planning agent 602 may send an update message to the shared message pool to notify coordination agent of the answer. Coordination agent 202 may check the answer generated by planning agent 602 to see if the results meet the original expectation.

If the results meet the original expectation, then coordination agent 202 may initiate another message with the requirements for geology agent 604, which moves workflow 600 to the second step. Similarly, information, data, and output will flow through production agent 606 and finance agent 608, respectively.

If, however, the results do not meet the original expectation, (e.g., coordination agent 202 notices some issue with the outputs or some violation of the requirements), then coordination agent 202 may give a feedback message to planning agent 602 and wait for the revised results.

Further as shown in FIG. 6, each professional agent may also send information to other professional agents. For example, planning agent 602 may provide land parcel information to geology agent 604; geology agent 604 may send well placement information to production agent 606; and production agent 606 may send production estimates to finance agent 608. Thus, in addition to communication among agents via the shared message pool, professional agents may also communicate directly with each other.

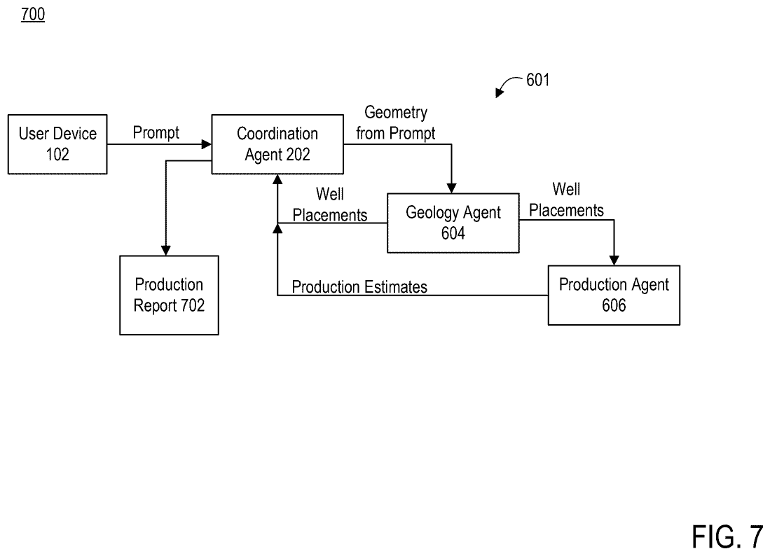

FIG. 7 is a schematic diagram illustrating a workflow 700 of a multi-agent framework system 601, according to example embodiments.

As shown, workflow 700 may being with user device 102 submitting a prompt. In some embodiments, user device 102 may submit a prompt via prompt interface 110 of application 108. In some embodiments, the user's prompt may be sent to server system 104. In such embodiments, server system 104 may send the prompt to LLM instances 120 via one or more APIs. In some embodiments, rather than send the user's prompt to server system 104, application 108 may route the user's prompt directly to LLM instances 120 via the one or more APIs, bypassing server system 104. In this particular example, the user's prompt may be: “I have this piece of land. What is the optimized oil production I can expect?”

As shown, workflow 700 may only need a subset of the professional agents required for workflow 600. For example, as shown, workflow 700 may utilize geology agent 604 and production agent 606. Each of planning agent 602 and production agent 606 may oversee a particular step in providing an answer to the user's prompt.

To begin, coordination agent 202 may receive the user's prompt. Coordination agent 202 may process the prompt and generate workflow 700 with steps defined by a standard operating procedure (SOP). Each step in workflow 700 may be specified by clear requirements and deliverables, sent through messages to the shared message pool, where all agents subscribe from and post message back. Coordination agent 202 may initiate the first message-including defining the recipient professional agent (i.e., the professional agent(s) supposed to respond to that message), together with the requirements and deliverables.

To understand the inventory of a given area, certain assumptions like the maximum/minimum of laterals and minimum requirement on spacing may be required. Since this information is not specified by the user in the user prompt, coordination agent 202 may need to infer or generate those parameters. For example, coordination agent 202 may take the average of maximum/minimum of laterals and minimum requirement on spacing within the same subplay. Coordination agent 202 may then generate workflow 700.

In some embodiments, workflow 700 may include a job for geology agent 604. For example, given the geometry of the land, coordination agent 202 may instruct geology agent 604 to retrieve the information regarding the existing wells in this area and the important attributes (e.g., operator, interval, play, subplay, etc.). To retrieve this information, geology agent 604 may call an analytical model (e.g., placed well analytics model), provide the analytical model with the available information, and receive generated well placements from the analytical model.

In some embodiments, workflow 700 may include a job for production agent 606. For example, given the well placements, coordination agent 202 may instruct production agent 606 to optimize the engineering design, including the completions and spacing parameters to maximize the oil production from the wells.

Coordination agent 202 may use the outputs from geology agent 604 and production agent 606 to generation production report 702 for the user.

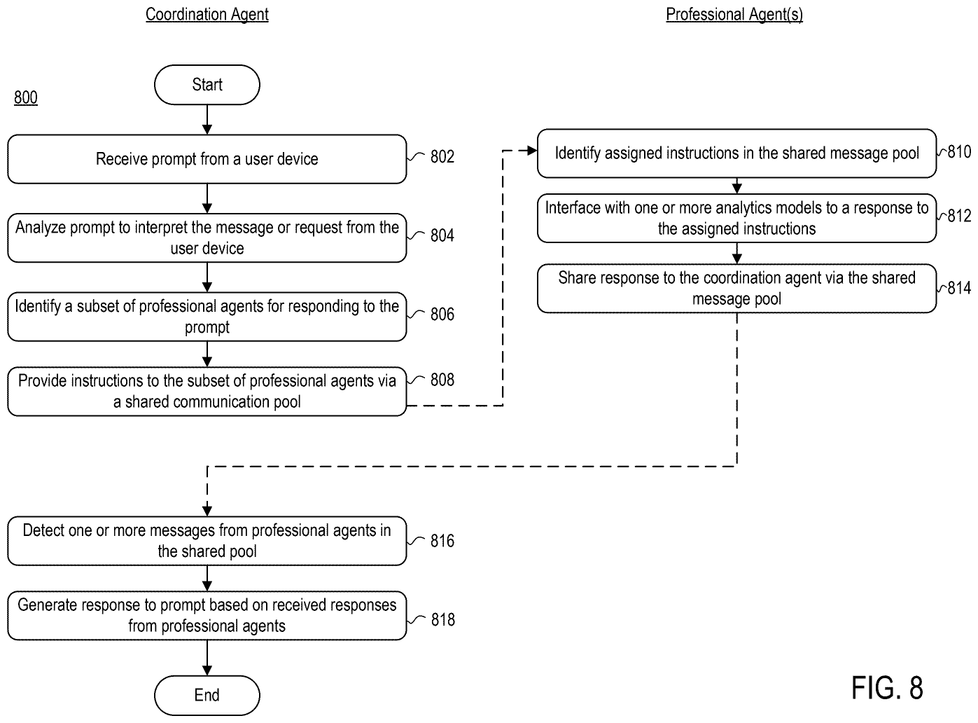

FIG. 8 is a flow diagram illustrating a method 800 of generating a response to a user prompt utilizing a multi-agent framework system, according to example embodiments. As shown, the flow diagram is split into two sides: a first side (e.g., left side) representing a series of steps performed by coordination agent 202 and second side (e.g., right side) representing a series of steps performed by a professional agent 204. Method 800 may begin at step 802.

At step 802, coordination agent 202 may receive a prompt from a user device 102. In some embodiments, coordination agent 202 may receive the prompt from user device 102 via prompt interface 110 of application 108. In some embodiments, coordination agent 202 may receive the user's prompt from server system 104. For example, coordination agent 202 may receive the prompt from server system 104 via one or more APIs. In some embodiments, coordination agent 202 may receive the user's prompt directly from user device 102 via the one or more APIs, bypassing server system 104.

At step 804, coordination agent 202 may analyze the prompt to interpret the message or request from user device 102. For example, coordination agent 202 may process the prompt and generate a workflow with steps defined by a standard operating procedure.

At step 806, coordination agent 202 may identify one or more professional agents 204 for responding to the prompt. For example, based on the workflow and/or the standard operating procedure, coordination agent 202 may identify one or more professional agents 204 to call in order to generate a proper response to the user's prompt.

At step 808, coordination agent 202 may generate and provide instructions to the identified professional agents 204 via shared communication pool 206. For example, each step in the workflow may be specified by clear requirements and deliverables, sent through messages to shared message pool 206, where all professional agents 204 subscribe from and post message back. Coordination agent 202 may initiate the first message-including defining the recipient professional agent (i.e., the professional agent(s) supposed to respond to that message), together with the requirements and deliverables.

At step 810, professional agent 204 may identify an assigned instruction in shared message pool 206. For example, each professional agent 204 may monitor shared message pool 206 to identify when coordination agent 202 or another professional agent 204 has posted a message for which it is an intended recipient. Professional agent 204 may identify that a message is assigned to it based on the recipient field in the message generated by coordination agent 202.

At step 812, professional agent 204 may interface with one or more analytics models to generate a response to the assigned instructions. For example, professional agent 204 may analyze the message to identify one or more constraints or requirements for generating a response to the message. In some embodiments, professional agent 204 may need to interface with one or more analytical models or tools 118 to generate a response to the instructions. In such embodiments, professional agent 204 may interface with one or more analytical models or tools 118 via one or more APIs. For example, via the one or more APIs, professional agent 204 may provide one or more analytical models or tools 118 with the necessary inputs in order to generate a desired response.

At step 814, professional agent 204 may share the response with coordination agent 202 via shared message pool 206. For example, professional agent 204 may generate a message intended for coordination agent 202. The message may include the answer to the instructions assigned to it by coordination agent 202.

At step 816, coordination agent 202 may identify message sent to it in shared message pool 206. For example, coordination agent 202 may monitor shared message pool 206 to identify professional agent 204 has posted a message for which it is an intended recipient. Coordination agent 202 may identify that a message is assigned to it based on the recipient field in the message generated by professional agent 204.

At step 818, coordination agent 202 may generate a response to the user's prompt based on the received responses from professional agents 204. For example, coordination agent 202 may use the outputs from professional agents 204 to generate a response to the user's prompt or query. Coordination agent 202 may deliver the response to user device 102 via application 108.

As those skilled in the art understand, before generating a response to the user's prompt, coordination agent may continue to initiate messages for additional professional agents 204 based on the generated workflow. As such, the response generated by coordination agent 202 may include an aggregation of outputs generated by multiple professional agents 204.

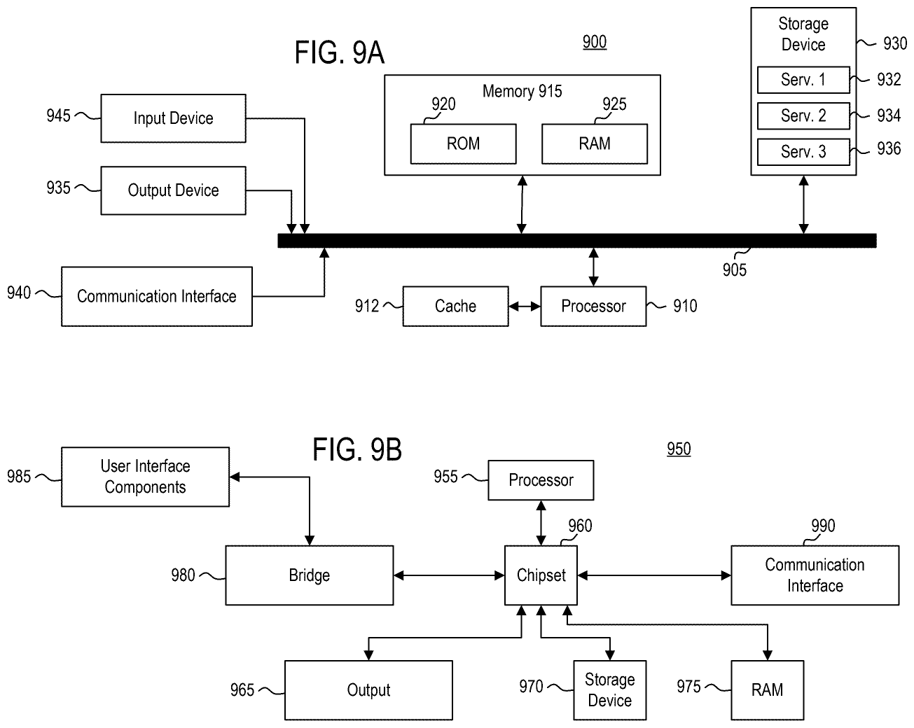

FIG. 9A illustrates a system bus architecture of computing system 900, according to example embodiments. System 900 may be representative of at least user device 102, server system 104, large language model system 106, computing system 400, or computing system 500. One or more components of system 900 may be in electrical communication with each other using a bus 905. System 900 may include a processing unit (CPU or processor) 910 and a system bus 905 that couples various system components including the system memory 915, such as read only memory (ROM) 920 and random-access memory (RAM) 925, to processor 910.

System 900 may include a cache of high-speed memory connected directly with, in close proximity to, or integrated as part of processor 910. System 900 may copy data from memory 915 and/or storage device 930 to cache 912 for quick access by processor 910. In this way, cache 912 may provide a performance boost that avoids processor 910 delays while waiting for data. These and other modules may control or be configured to control processor 910 to perform various actions. Other system memory 915 may be available for use as well. Memory 915 may include multiple different types of memory with different performance characteristics. Processor 910 may include any general-purpose processor and a hardware module or software module, such as service 1 932, service 2 934, and service 3 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction with the computing system 900, an input device 945 may represent any number of input mechanisms, such as a microphone for speech, a touch-sensitive screen for gesture or graphical input, keyboard, mouse, motion input, speech and so forth. An output device 935 may also be one or more of a number of output mechanisms known to those of skill in the art. In some instances, multimodal systems may enable a user to provide multiple types of input to communicate with computing system 900. Communications interface 940 may generally govern and manage the user input and system output. There is no restriction on operating on any particular hardware arrangement and therefore the basic features here may easily be substituted for improved hardware or firmware arrangements as they are developed.

Storage device 930 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 925, read only memory (ROM) 920, and hybrids thereof.

Storage device 930 may include services 932, 934, and 936 for controlling the processor 910. Other hardware or software modules are contemplated. Storage device 930 may be connected to system bus 905. In one aspect, a hardware module that performs a particular function may include the software component stored in a computer-readable medium in connection with the necessary hardware components, such as processor 910, bus 905, output device 935 (e.g., display), and so forth, to carry out the function.

FIG. 9B illustrates a computer system 950 having a chipset architecture that may represent user device 102, server system 104, large language model system 106, computing system 400, or computing system 500. Computer system 950 may be an example of computer hardware, software, and firmware that may be used to implement the disclosed technology. System 950 may include a processor 955, representative of any number of physically and/or logically distinct resources capable of executing software, firmware, and hardware configured to perform identified computations. Processor 955 may communicate with a chipset 960 that may control input to and output from processor 955.

In this example, chipset 960 outputs information to output 965, such as a display, and may read and write information to storage device 970, which may include magnetic media, and solid-state media, for example. Chipset 960 may also read data from and write data to storage device 975 (e.g., RAM). A bridge 980 for interfacing with a variety of user interface components 985 may be provided for interfacing with chipset 960. Such user interface components 985 may include a keyboard, a microphone, touch detection and processing circuitry, a pointing device, such as a mouse, and so on. In general, inputs to system 950 may come from any of a variety of sources, machine generated and/or human generated.

Chipset 960 may also interface with one or more communication interfaces 990 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 955 analyzing data stored in storage device 970 or storage device 975. Further, the machine may receive inputs from a user through user interface components 985 and execute appropriate functions, such as browsing functions by interpreting these inputs using processor 955.

It may be appreciated that example systems 900 and 950 may have more than one processor 910 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method for coordinating tasks within an energy industry using a multi-agent artificial intelligence system, the method comprising:
receiving, by a coordination agent of a multi-agent artificial intelligent system, a user prompt related to an energy industry operation via a prompt interface;
analyzing, by the coordination agent, the user prompt to interpret content, intent, and relevant context associated with the energy industry operation;
generating, by the coordination agent, a workflow based on an analysis of the user prompt, wherein the workflow defines a sequence of tasks to be executed by a plurality of professional agents, each task corresponding to a specialized function within the energy industry;
communicating, by the coordination agent, the workflow to the plurality of professional agents via a shared message pool, wherein each professional agent is configured to perform a specific role related to the user prompt;
receiving, by the coordination agent from the plurality of professional agents, responses to the workflow, wherein each response includes outputs from tasks executed by the plurality of professional agents; and
compiling, by the coordination agent, a response to the user prompt based on the received responses from the plurality of professional agents, wherein the response is tailored to address the user prompt within a context of the energy industry operation.

2. The method of claim 1, wherein communicating, by the coordination agent, the workflow to the plurality of professional agents via the shared message pool comprises:
identifying a first professional agent to perform a first step in the workflow;
generating a message intended for the first professional agent, wherein the message comprises an indication of the first professional agent as a recipient of the message and instructions for the first professional agent to perform a task associated with the first step in the workflow; and
publishing the message in the shared message pool.

3. The method of claim 2, wherein receiving, by the coordination agent from the plurality of professional agents, responses to the workflow comprises:
receiving, from the first professional agent, a first output corresponding to the task; and
analyzing, by the coordination agent, the first output to determine whether the first output satisfies the first step in the workflow.

4. The method of claim 3, further comprising:
determining, by the coordination agent, that the first output does not satisfy the first step in the workflow; and
responsive to the determining, generating, by the coordination agent, an updated message intended for the first professional agent, the updated message instructing the first professional agent to re-perform the task.

5. The method of claim 3, further comprising:
determining, by the coordination agent, that the first output does satisfy the first step in the workflow; and
responsive to the determining:
identifying a second professional agent to perform a second step in the workflow;
generating a second message intended for the second professional agent, wherein the second message comprises a second indication of the second professional agent as a second recipient of the second message and second instructions for the second professional agent to perform a second task associated with the second step in the workflow; and
publishing the second message in the shared message pool.

6. The method of claim 2, further comprising:
generating, by the first professional agent, a first output by analyzing the instructions in the message.

7. The method of claim 6, wherein generating, by the first professional agent, the first output by analyzing the instructions in the message comprises:
determining a first analytical model for generating the first output; and
responsive to the determining, calling the first analytical model to generate the first output by passing inputs to the first analytical model via one or more application programming interfaces.

8. A non-transitory computer readable medium comprising one or more sequences of instructions, which, when executed by a processor, causes a computing system to perform operations comprising:
receiving, by a coordination agent of a multi-agent artificial intelligent system, a user prompt related to an energy industry operation via a prompt interface;
analyzing, by the coordination agent, the user prompt to interpret content, intent, and relevant context associated with the energy industry operation;
generating, by the coordination agent, a workflow based on an analysis of the user prompt, wherein the workflow defines a sequence of tasks to be executed by a plurality of professional agents, each task corresponding to a specialized function within the energy industry;
communicating, by the coordination agent, the workflow to the plurality of professional agents via a shared message pool, wherein each professional agent is configured to perform a specific role related to the user prompt;
receiving, by the coordination agent from the plurality of professional agents, responses to the workflow, wherein each response includes outputs from tasks executed by the plurality of professional agents; and
compiling, by the coordination agent, a response to the user prompt based on the received responses from the plurality of professional agents, wherein the response is tailored to address the user prompt within a context of the energy industry operation.

9. The non-transitory computer readable medium of claim 8, wherein communicating, by the coordination agent, the workflow to the plurality of professional agents via the shared message pool comprises:
identifying a first professional agent to perform a first step in the workflow;
generating a message intended for the first professional agent, wherein the message comprises an indication of the first professional agent as a recipient of the message and instructions for the first professional agent to perform a task associated with the first step in the workflow; and
publishing the message in the shared message pool.

10. The non-transitory computer readable medium of claim 9, wherein receiving, by the coordination agent from the plurality of professional agents, responses to the workflow comprises:
receiving, from the first professional agent, a first output corresponding to the task; and
analyzing, by the coordination agent, the first output to determine whether the first output satisfies the first step in the workflow.

11. The non-transitory computer readable medium of claim 10, further comprising:
determining, by the coordination agent, that the first output does not satisfy the first step in the workflow; and
responsive to the determining, generating, by the coordination agent, an updated message intended for the first professional agent, the updated message instructing the first professional agent to re-perform the task.

12. The non-transitory computer readable medium of claim 10, further comprising:
determining, by the coordination agent, that the first output does satisfy the first step in the workflow; and
responsive to the determining:
identifying a second professional agent to perform a second step in the workflow;
generating a second message intended for the second professional agent, wherein the second message comprises a second indication of the second professional agent as a second recipient of the second message and second instructions for the second professional agent to perform a second task associated with the second step in the workflow; and
publishing the second message in the shared message pool.

13. The non-transitory computer readable medium of claim 9, further comprising:
generating, by the first professional agent, a first output by analyzing the instructions in the message.

14. The non-transitory computer readable medium of claim 13, wherein generating, by the first professional agent, the first output by analyzing the instructions in the message comprises:
determining a first analytical model for generating the first output; and
responsive to the determining, calling the first analytical model to generate the first output by passing inputs to the first analytical model via one or more application programming interfaces.

15. A multi-agent artificial intelligence system comprising:
a coordination agent; and
a plurality of professional agents communicating with the coordination agent via a shared message pool, the coordination agent and the plurality of professional agents configured to perform operations comprising:
receiving, by the coordination agent of a multi-agent artificial intelligent system, a user prompt related to an energy industry operation via a prompt interface;
analyzing, by the coordination agent, the user prompt to interpret content, intent, and relevant context associated with the energy industry operation;
generating, by the coordination agent, a workflow based on an analysis of the user prompt, wherein the workflow defines a sequence of tasks to be executed by the plurality of professional agents, each task corresponding to a specialized function within the energy industry;
communicating, by the coordination agent, the workflow to the plurality of professional agents via the shared message pool, wherein each professional agent is configured to perform a specific role related to the user prompt;
receiving, by the coordination agent from the plurality of professional agents, responses to the workflow, wherein each response includes outputs from tasks executed by the plurality of professional agents; and
compiling, by the coordination agent, a response to the user prompt based on the received responses from the plurality of professional agents, wherein the response is tailored to address the user prompt within a context of the energy industry operation.

16. The multi-agent artificial intelligence system of claim 15, wherein communicating, by the coordination agent, the workflow to the plurality of professional agents via the shared message pool comprises:
identifying a first professional agent to perform a first step in the workflow;
generating a message intended for the first professional agent, wherein the message comprises an indication of the first professional agent as a recipient of the message and instructions for the first professional agent to perform a task associated with the first step in the workflow; and
publishing the message in the shared message pool.

17. The multi-agent artificial intelligence system of claim 16, wherein receiving, by the coordination agent from the plurality of professional agents, responses to the workflow comprises:
receiving, from the first professional agent, a first output corresponding to the task; and
analyzing, by the coordination agent, the first output to determine whether the first output satisfies the first step in the workflow.

18. The multi-agent artificial intelligence system of claim 17, further comprising:
determining, by the coordination agent, that the first output does not satisfy the first step in the workflow; and
responsive to the determining, generating, by the coordination agent, an updated message intended for the first professional agent, the updated message instructing the first professional agent to re-perform the task.

19. The multi-agent artificial intelligence system of claim 17, further comprising:
determining, by the coordination agent, that the first output does satisfy the first step in the workflow; and
responsive to the determining:
identifying a second professional agent to perform a second step in the workflow;
generating a second message intended for the second professional agent, wherein the second message comprises a second indication of the second professional agent as a second recipient of the second message and second instructions for the second professional agent to perform a second task associated with the second step in the workflow; and
publishing the second message in the shared message pool.

20. The multi-agent artificial intelligence system of claim 16, further comprising:
generating, by the first professional agent, a first output by analyzing the instructions in the message, the generating comprising:
determining a first analytical model for generating the first output; and
responsive to the determining, calling the first analytical model to generate the first output by passing inputs to the first analytical model via one or more application programming interfaces.
